(19) United States
(12) Patent Application Publication
(10) Pub. No.: US 2005/0267631 A1
(43) Pub. Date: Dec. 1, 2005

(54) Mobile robot and system and method of compensating for path diversions

(76) Inventors: Ju-sang Lee, Gwangju-city (KR); Jang-youn Ko, Gwangju-city (KR); Jeong-gon Song, Gwangju-city (KR); Kwang-soo Lim, Seoul (KR); Ki-man Kim, Gwangju-city (KR); Sam-jong Jeung, Gwangju-city (KR)

Correspondence Address: LADAS & PARRY LLP, 224 SOUTH MICHIGAN AVENUE, SUITE 1600, CHICAGO, IL, 60604, US

(21) Appl. No.: 10/991,073

(22) Filed: Nov. 17, 2004

(30) Foreign Application Priority Data
May 14, 2004 (KR) 2004-34364

(51) Int. Cl. G06F 19/00

(52) U.S. Cl. 700/245

(57) ABSTRACT

A mobile robot measures a rotation angle using information from an image photographed by a vision camera. A mobile robot system comprises a main body of the robot, a driving part for driving a plurality of wheels; a vision camera mounted on a main body thereof to photograph an upper image which is perpendicular to a traveling direction; and a controller for calculating a rotation angle using polar-mapping image data obtained by polar-mapping a ceiling image, photographed by the vision camera, with respect to a ceiling of a working area. The controller drives the driving part using a calculated rotation angle. The rotation angle is measured by the vision cameras and the rotation angle can be used to compensate the working path, without having to provide expensive devices such as an accelerometer or a gyroscope, thereby saving manufacturing cost.

### CROSS-REFERENCE TO RELATED APPLICATIONS

This application claims the benefit of Korean Patent Application No. 2004-34364, filed May 14, 2004, in the Korean Intellectual Property Office, the disclosure of which is incorporated herein by reference.

### FIELD OF THE INVENTION

The present invention relates generally to a mobile robot, which automatically travels around, a mobile robot system, and a method of compensating for path diversions thereof. More particularly, the present invention relates to a mobile robot that measures a rotation angle using information from an image photographed by a vision camera, thereby compensating for path diversions of the robot, and a mobile robot system.

### BACKGROUND OF THE INVENTION

In general, a mobile robot defines a working area surrounded by walls or obstacles using an ultrasonic wave sensor mounted in a main body thereof and travels along a working path programmed beforehand, thereby performing a main operation such as a cleaning work or a patrolling work. While traveling, the mobile robot calculates traveling angle and distance and a current location using a rotation detecting sensor such as an encoder, which detects a revolution per minutes (RPM) of a wheel and a rotation angle, and drives the wheel to travel along the programmed working path.

However, when the encoder recognizes the current location and detects the rotation angle, an error may occur between an estimated travel angle, which is calculated by a signal that the encoder detects, and an actual travel angle, due to slip of the wheel and unevenness of a floor surface during the travel. The error of the detected rotation angle is accumulated as the mobile robot travels, and accordingly, the mobile robot may deviate from the programmed working path. As a result, the mobile robot may fail to completely perform its work in the working area or repeat the work in only a certain area, thereby deteriorating a working efficiency.

To overcome the above problem, a mobile robot has been introduced, which is further provided with an accelerometer or a gyroscope for detecting the rotation angle, instead of the encoder.

The mobile robot provided with the accelerometer or the gyroscope can improve the problem of error in detecting the rotation angle. However, the accelerometer or the gyroscope increases manufacturing cost.

### SUMMARY OF THE INVENTION

An aspect of the present invention is to solve at least the above problems and/or disadvantages and to provide at least the advantages described below. Accordingly, an aspect of the present invention is to provide a mobile robot capable of locating itself using a vision camera and capable of compensating a path by correctly detecting a rotation angle without requiring dedicated devices for detecting the rotation angle, a mobile robot system and a method for compensating the path.

In order to achieve the above-described aspects of the present invention, there is provided a mobile robot comprising a driving part for driving a plurality of wheels, a vision camera mounted on a main body thereof to photograph an upper image that is substantially perpendicular to a direction of travel for the robot; and a controller for calculating a rotation angle using polar-mapping image data obtained by polar-mapping a ceiling image, photographed by the vision camera, with respect to a ceiling of a working area, and driving/controlling the driving part using the calculated rotation angle.

The controller calculates the rotation angle by comparing current polar-mapping image data, obtained by polar-mapping a current ceiling image photographed by the vision camera, with previous polar-mapping image data which is previously stored.

The mobile robot further comprises a vacuum cleaner having a suction part for drawing in dust or contaminants from a floor. A dust collecting part stores drawn-in dust or contaminants. A suction motor generates a suction force.

According to another aspect of the present invention, there is provided a mobile robot having a driving part driving a plurality of wheels and a vision camera mounted on a main body thereof to photograph an upper image which is perpendicular to a traveling direction; and a remote controller for wirelessly communicating with the mobile robot, and the remote controller calculates the rotation angle using polar-mapping image data obtained by polar-mapping a ceiling image, photographed by the vision camera, with respect to a ceiling of the working area, and controls a working path of the mobile robot using the calculated rotation angle.

The remote controller calculates the rotation angle by comparing current polar-mapping image data, obtained by polar-mapping a current ceiling image photographed by the vision camera, with previous polar-mapping image data which is previously stored.

The mobile robot further comprises a vacuum cleaner having a suction part for drawing in dust or contaminants, a dust collecting part for storing the drawn-in dust or contaminants, and a suction motor part for generating a suction force.

According to yet another aspect of the present invention, there is provided a method for compensating a path of a mobile robot, the method comprising the steps of storing initial polar-mapping image data obtained by polar-mapping an initial ceiling image photographed by a vision camera; changing a traveling angle of the mobile robot, so that the mobile robot is diverted according to at least one of a working path programmed in advance and an obstacle; and after changing the traveling angle of the mobile robot, comparing the initial polar-mapping image data with current polar-mapping image data obtained by polar-mapping the current ceiling image photographed by the vision camera, thereby adjusting the rotation angle of the mobile robot.

The adjusting step comprises the steps of forming current polar-mapping image data by polar-mapping the current ceiling image photographed by the vision camera; circular-matching the current polar-mapping image data and the initial polar-mapping image data in a horizontal direction; calculating the rotation angle of the mobile robot based on a distance that the current polar-mapping image data is shifted in the initial polar-mapping image data; and comparing the calculated rotation angle of the mobile robot with at least one of directions; a traveling direction according to a preset working path and a traveling direction for avoiding an obstacle, thereby controlling a driving part of the mobile robot adjust the traveling angle of the mobile robot.

According to yet another aspect of the present invention, there is provided a method for compensating a path of a mobile robot, comprising the steps of storing initial polar-mapping image data obtained by polar-mapping an initial ceiling image photographed by a vision camera; changing a traveling angle of the mobile robot, so that the mobile robot is diverted according to at least one of a working path programmed in advance and an obstacle; while the robot cleaner changes the traveling angle, determining whether the rotation angle of the mobile robot corresponds to at least one of directions; a traveling direction according to a preset working path and a traveling direction for avoiding an obstacle, by comparing the initial polar-mapping image data with real-time polar-mapping image data, obtained by polar-mapping the ceiling image photographed real time or at regular intervals by the vision camera; and stopping changing of the traveling angle of the mobile robot when the traveling angle of the mobile robot corresponds to the at least one of the directions; a traveling direction according to a preset working path and a traveling direction for avoiding an obstacle.

The determining step comprises the steps of forming real-time polar-mapping image data by polar-mapping the real-time ceiling image photographed real time or at regular intervals by the vision camera; circular-matching the real-time polar-mapping image data and the initial polar-mapping image data in a horizontal direction; calculating the rotation angle of the mobile robot based on a distance that the real-time polar-mapping image data is shifted in the initial polar-mapping image data; and comparing the calculated rotation angle of the mobile robot with the at least one of the directions; a traveling direction according to a preset working path and a traveling direction for avoiding an obstacle, to determine whether the compared values correspond.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a perspective view of a robot cleaner applying a mobile robot according to an embodiment of the present invention, with a cover thereof removed;

FIG. 2 is a block diagram illustrating a robot cleaner system applying a mobile robot system according to an embodiment of the present invention;

FIG. 3 is a block diagram illustrating a central controller of FIG. 2;

FIG. 4 is a view for showing an example where an image photographed by an upper vision camera of the robot cleaner of FIG. 1 is compensated;

FIG. 5 is a view for showing a principle of circular matching of polar-mapping images before and after rotation of the robot cleaner of FIG. 1 by a predetermined angle;

FIGS. 6A and 6B are views for showing a principle of extracting a polar-mapping image from a ceiling image photographed by the upper vision camera of the robot cleaner of FIG. 1 and compensated;

FIG. 7 is a flowchart for illustrating a method for compensating a path of a robot cleaner employing a mobile robot according to a first embodiment of the present invention; and

FIG. 8 is a flowchart for illustrating a method for compensating a path of the robot cleaner employing the mobile robot according to a second embodiment of the present invention.

### DETAILED DESCRIPTION OF THE EXEMPLARY EMBODIMENTS

Hereinafter, an embodiment of the present invention will be described in detail with reference to the accompanying drawing figures.

In the following description, the same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

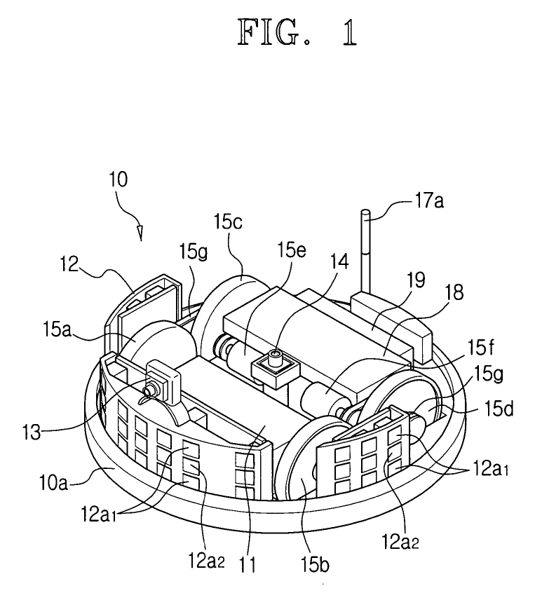

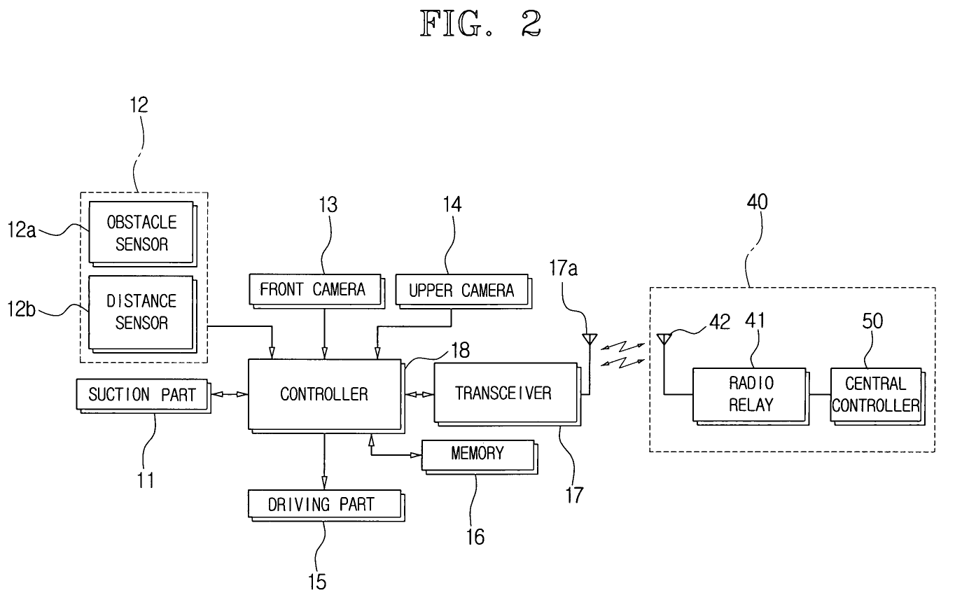

Referring to FIGS. 1 and 2, a robot cleaner 10 comprises a suction part 11, a sensor 12, a front vision camera 13, an upper vision camera 14, a driving part 15, a memory 16, a transceiver 17, a controller 18 and a battery 19.

The suction part 11 is mounted on a main body 10a to draw in air from a floor. The suction part 11 comprises a suction motor (not shown), a dust collecting chamber for collecting the dust, drawn in through a suction inlet or a suction pipe formed to face the floor.

The sensor 12 comprises obstacle sensors 12a (FIG. 2) disposed at regular intervals along a circumference of a flank side of the main body 10a in order to externally transmit a signal and receive a reflected signal, and distance sensors 12b (FIG. 2) for detecting a traveling distance of the robot cleaner 10.

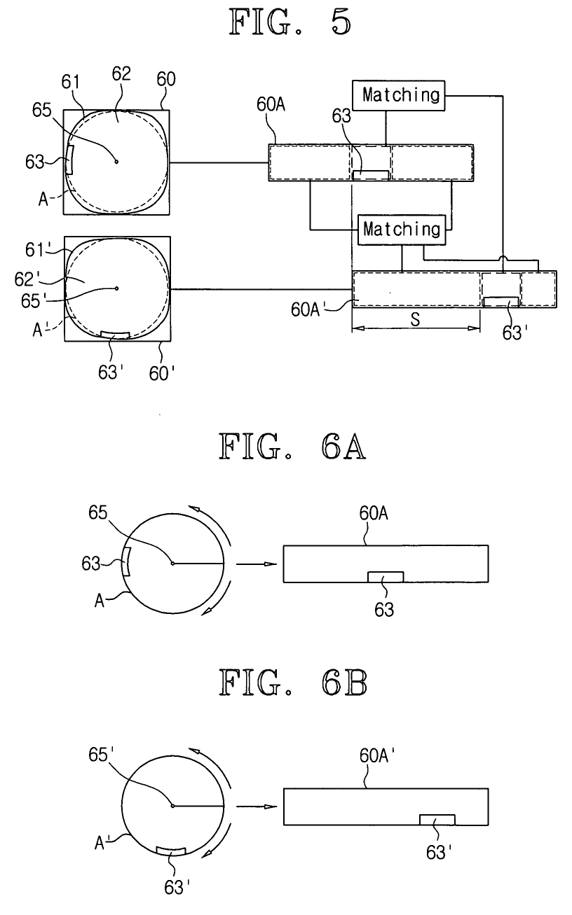

The obstacle sensor 12a comprises infrared ray emitters 12a1 for emitting an infrared ray and light receivers 12a2 for receiving a reflected ray, which are disposed as vertical groups along the circumference of the flank side of the main body 10a. Alternatively, an ultrasonic wave sensor capable of receiving a reflected supersonic wave may be applied for the obstacle sensor 12a. The obstacle sensor 12a is also used in measuring a distance to an obstacle or walls 61 and 61′ (FIG. 5).

The distance sensor 12b may employ one or more rotation detecting sensors, which detect revolutions per minute (RPM) of wheels 15a to 15d. For example, an encoder may be applied for the rotation-detecting sensor, which detects the RPM of motors 15e and 15f.

The front vision camera 13 is mounted on the main body 10a to photograph an image on the front and outputs the photographed front image to the controller 18.

The upper vision camera 14, mounted on the main body 10a to photograph an image of an upper part such as ceilings 62 and 62′ (FIG. 5), outputs the photographed upper image to the controller 18. The upper vision camera 14 may use a fisheye lens (not shown).

A fisheye lens comprises at least one lens having a wide visual angle of approximately 180°, like a fisheye. The image photographed by a wide-angle fisheye lens is distorted, as shown in FIG. 5, as if a space in the working area defined by the ceilings 62 and 62′ and the walls 61 and 61′ is mapped on a hemispheric surface. Therefore, the fisheye lens is properly designed in consideration of the desired visual angle or an allowable distortion degree. Since the fisheye lens is disclosed in Korean Patent Publication Nos. 1996-7005245, 1997-48669 and 1994-22112, and has already placed on the market by several lens manufacturers, detailed description of the fisheye lens will be omitted.

The driving part 15 comprises a pair of front wheels 15a and 15b disposed on opposite sides at the front, a pair of rear wheels 15c and 15d disposed on opposite sides at the rear, motors 15e and 15f for rotating the rear wheels 15c and 15d, and a timing belt 15g for transmitting a driving force generated at the rear wheels 15c and 15d to the front wheels 15a and 15b. The driving part 15, being controlled by a signal from the controller 18, independently drives the respective motors 15e and 15f clockwise and/or counterclockwise. By driving the motors 15e and 15f by different RPMs, a traveling direction of the robot cleaner 10 can be diverted.

The transceiver 17 sends data for transmission through an antenna 17a and transmits a signal received through the antenna 17a to the controller 18.

The controller 18 processes the signal received through the transceiver 17 and controls each part of the robot cleaner 10. If a key input device (not shown) having a plurality of keys for setting functions is provided on the main body 10a, the controller 18 processes a key signal input from the key input device.

When the robot cleaner 10 starts traveling by the front wheels 15a and 15b of the driving part 15, the controller 18 controls the motors 15e and 15f of the driving part 15 to drive the robot cleaner 10 according to a working path programmed in advance.

Ceiling images 60 and 60′ (FIG. 5) photographed by the upper vision camera 14 employing the fisheye lens, is compensated with respect to the ceilings 62 and 62′ of the working area. Then, circular matching is performed with respect to the ceiling images 60 and 60′ in a horizontal direction using polar-mapping image data obtained by polar-mapping which maps the planar ceiling images 60 and 60′ from an image center thereof onto a parameter space of polar coordinates (ρ, θ). Accordingly, a rotation angle of the robot cleaner 10 is calculated.

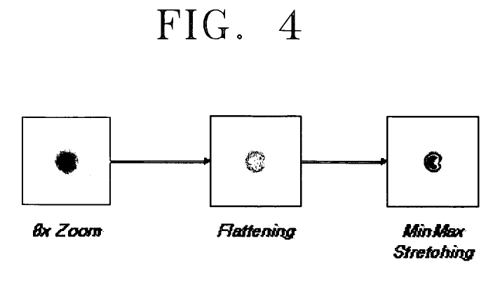

The compensation of the ceiling images 60 and 60′ comprises steps of flattening in which bias information and low frequency component are removed from the ceiling images 60 and 60′ photographed by the upper vision camera 14 and Min-Max stretching in which change of lighting is removed from the flattened images. FIG. 4 illustrates an example of a circular spot image photographed by the upper vision camera 14 being compensated. The compensation of the ceiling image is performed to easily extract a similar part of the image when the circular matching is performed with respect to polar-mapping images 60A and 60A′ obtained by polar-mapping to calculate the rotation angle later. Therefore, an image compensation part (not shown) which compensates the image is preferably mounted in the controller 18.

After the ceiling images 60 and 60′ are compensated, the controller 18 compares the polar-mapping image 60A stored by the upper vision camera 14 with the polar-mapping image 60A′ obtained by polar-mapping the compensated ceiling image, thereby calculating a shifted distance S between parts of high similarity. Accordingly, the controller 18 calculates the rotation angle, a method for which is described hereinafter in greater detail and depicted in FIG. 5.

FIG. 5 illustrates a method of circular matching with respect to the two polar-mapping images 60A and 60A′ in a horizontal direction in order to measure a similarity between the polar-mapping image 60A before rotation of the robot cleaner 10 by a certain angle and the polar-mapping image 60A′ after the rotation and calculate the shifted distance S between the parts of high similarity.

More specifically, as shown in FIGS. 6A and 6B, the controller 18 performs polar-mapping, from centers 65 and 65′, with respect to certain areas A and A′ which include construction images 63 and 63′ in the whole screen of the ceiling images 60 and 60′ photographed by the upper vision camera 14 and compensated, using a following expression 1 in which a Cartesian coordinate (x, y) constructed by an X-axis and a Y-axis is converted to a parameter of a polar coordinate (ρ, θ), and projects the areas A and A′ in a direction of the Y-axis, thereby extracting the polar-mapping images 60A and 60A′.
P(ρ, θ) Expression 1
herein, ρ=\sqrt{x²+y²}, and θ=arctan (y/x)

The certain areas A and A′ for extracting the polar-mapping images 60A and 60A′ are set as the same parts in the whole screen of the ceiling images 60 and 60′, regardless of their sizes. In illustrating the ceiling images 60 and 60′, only the construction images 63 and 63′ are illustrated, excluding other images such as lightings, for convenience.

As shown in FIG. 5, the controller 18 performs circular matching with respect to the two polar-mapping images 60A and 60A′ in a horizontal direction, in order to measure a similarity between the polar-mapping image 60A of the ceiling image 60 of before rotation of the robot cleaner 10 by a certain angle and the polar-mapping image 60A′ after the rotation, and calculate the shifted distance S between the parts of high similarity, thereby obtaining the rotation angle of the robot cleaner 10.

While measuring the rotation angle, if the polar-mapping image 60A′ is not captured from the current ceiling image 60′ photographed by the upper vision camera 14, the controller 18 can temporarily control driving of the robot cleaner 10 using a moving distance and direction information which are calculated by the encoder of the distance sensor 12b.

An embodiment has been described so far, in which the controller 18 of the robot cleaner 10 measures the rotation angle thereof by itself, using the polar-mapping images 60A and 60A′ of the ceiling images 60 and 60′ photographed by the upper vision camera 14.

According to another aspect of the present invention, a robot cleaner system is introduced to perform the polar-mapping and the circular-matching of the ceiling images 60 and 60′ of the robot cleaner 10 at the outside so as to reduce an operation load required in polar-mapping and circular-matching of the ceiling images 60 and 60′.

In the above robot cleaner system, the robot cleaner 10 wirelessly transmits information on the photographed image to the outside and operates in accordance with a control signal received from the outside, and a remote controller 40 wirelessly controls and drives the robot cleaner 10.

The remote controller 40 comprises a radio relay 41 and a central controller 50.

The radio relay 41 processes a wireless signal received from the robot cleaner 10 and transmits the signal by wire to the central controller 50. Additionally, the radio relay 41 wirelessly transmits the signal received from the central controller 50 to the robot cleaner 10 through an antenna 42.

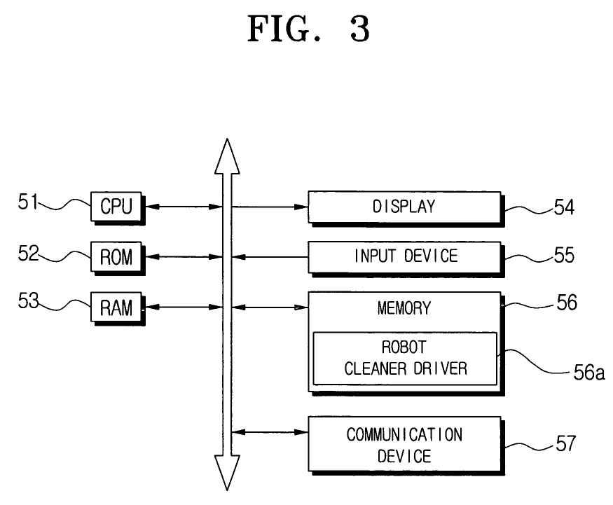

The central controller 50 may be implemented by a general computer, as shown in FIG. 3. Referring to FIG. 3, the central controller 50 comprises a central processing unit (CPU) 51, a read-only memory (ROM) 52, a random-access memory (RAM) 53, a display 54, an input device 55, a memory 56 and a communication device 57.

The memory 56 comprises a robot cleaner driver 56a for controlling the robot cleaner 10 and processing the signal transmitted from the robot cleaner 10.

The robot cleaner driver 56a offers a menu for setting the control of the robot cleaner 10 through the display 54 and processes so that a menu selected by a user is performed by the robot cleaner 10. The menu may be divided into a main menu comprising a cleaning work and a monitoring work, and a sub menu comprising a working area selection list and operation methods, for example.

The robot cleaner driver 56a controls the robot cleaner 10 to determine the rotation angle of the robot cleaner 10 using the current polar-mapping image 60A′ obtained by polar-mapping the current ceiling image 60′ received from the upper vision cameral 14 and the polar-mapping image 60A of the ceiling image 60 which is previously stored.

The controller 18 of the robot cleaner 10 controls the driving part 15 according to controlling information received through the radio relay 41 from the robot cleaner driver 56a. The operation load for processing the image is omitted. In addition, the controller 18 transmits the ceiling image, which is photographed during traveling of the robot cleaner 10, to the central controller 50 through the radio relay 41.

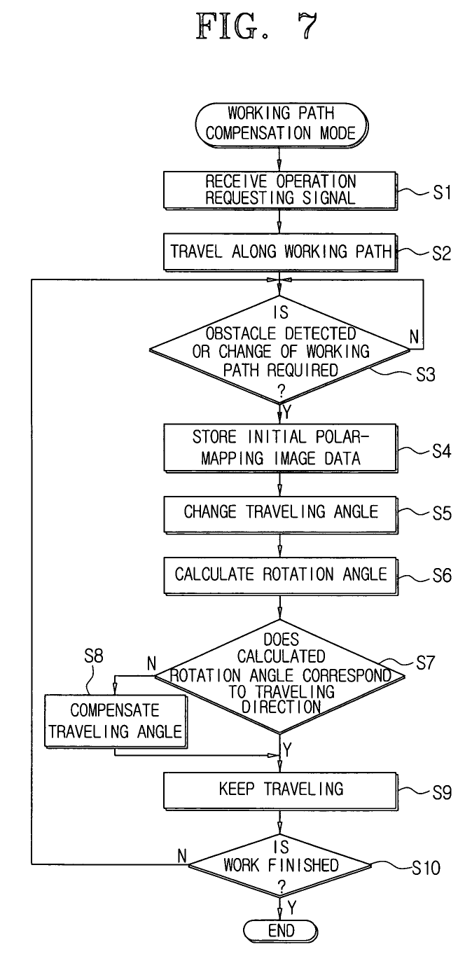

Hereinbelow, a method for compensating a path of the robot cleaner 10, according to a first embodiment of the present invention, will be described in greater detail with reference to FIG. 7.

In step S1, the controller 18 determines whether an operation requesting signal is received by the robot cleaner 10.

If an operation requesting signal is received by the controller 18, the controller 18 transmits a traveling command and a sensing signal to the driving part 15 and the sensor 12.

In step S2, the aforementioned driving part 15 drives the motors 15e and 15f according to the signal of the controller 18 and starts the robot cleaner 10 traveling along a working path that is programmed in advance.

The obstacle sensor 12a and the distance sensor 12b transmit a sensing signal to the controller 18.

In step S3, while the robot cleaner 10 is traveling, the controller 18 determines whether the obstacle sensor 12a detects any obstacles such as the walls 61 and 61′ and decides whether to divert the robot cleaner 10 according to the working path programmed in advance (S3). In this embodiment, the robot cleaner 10 changes its traveling direction according to the working path programmed in advance.

If diversion of the robot cleaner 10 is required, step S4 is executed as a result of the test performed in step S3. In step S4, the controller 18 stops the motors 15e and 15f of the driving part 15, photographs the ceiling image 60 through the upper vision camera 14, extracts the polar-mapping image 60A by compensating and polar-mapping the photographed ceiling image 60, and stores extracted polar-mapping image data as a default value (S4). If diversion of the robot 10 is not required, program control proceeds to step S10 where a determination is made whether the programmed work is finished.

In step S5, the controller 18 transmits a command to the motors 15e and 15f of the driving part 15, diverting the robot cleaner 10 in accordance with the traveling angle of the programmed working path and changes the traveling angle of the robot cleaner 10 (S5).

After the robot cleaner 10 changes the traveling angle by the driving part 15, the controller 18 photographs the ceiling image 60′ again by the upper vision camera 14, extracts the polar-mapping image 60A′ by compensating and polar-mapping the photographed ceiling image 60′, and performs circular-matching with respect to the extracted polar-mapping image data and previous polar-mapping image data, thereby calculating the traveling angle of the robot cleaner 10 (S6).

After that, the controller 18 compares a traveling direction of the programmed working path with the calculated rotation angle of the robot cleaner 10 (S7).

In step S7, if the traveling direction and the calculated rotation angle do not correspond and compensation of the traveling angle is therefore required, the controller 18 controls the motors 15e and 15f of the driving part 15 using the calculated rotation angle information of the robot cleaner 10, such that the rotation angle of the robot cleaner 10 is compensated as much as required (S8).

After the robot cleaner 10 compensates the traveling angle by the driving part 15, the controller 18 drives the motors 15e and 15f to keep traveling of the robot cleaner 10 (S9).

The controller 18 determines whether performance such as moving to a destination, the cleaning work or the monitoring work has been completed (S10), and when the performance is not completed, processes of S3 through S10 are repeated until the performance is all done.

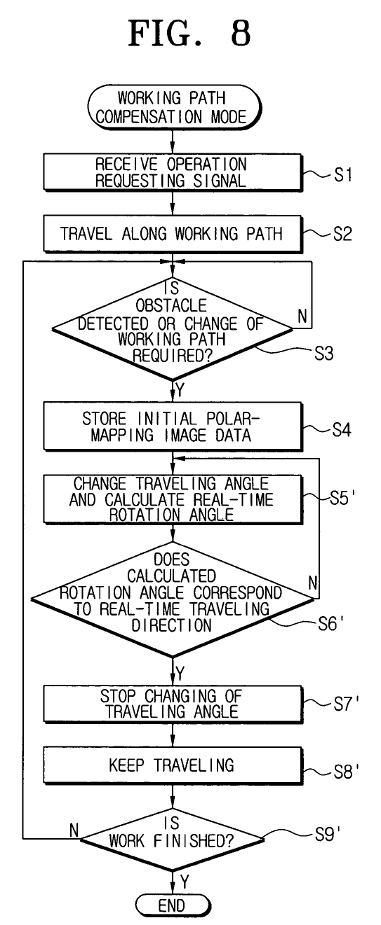

Hereinbelow, a method for compensating a working path of the robot cleaner 10 according to a second embodiment of the present invention will be described in greater detail with reference to FIG. 8.

In step S1, the controller 18 determines whether an operation requesting signal is received by the robot cleaner 10 that has been standing at a certain location through the key input device or wirelessly from the outside (S1), and performs processes of S2 to S4 as in the first embodiment of the compensating method.

After step S4, the controller 18 transmits to the motors 15e and 15f a command for diverting the robot cleaner 10 in accordance with the traveling angle of the programmed working path and changes the traveling angle of the robot cleaner 10. Also, while the robot cleaner 10 changes the traveling angle by the driving part 15, the controller 18 photographs the ceiling image 60′ real time or at regular intervals by the upper vision camera 14, extracts the polar-mapping image 60A′ by compensating and polar-mapping the real time photographed ceiling image 60′, and performs circular-matching with respect to the extracted real-time polar-mapping image data and previously stored polar-mapping image data, thereby calculating the rotation angle of the robot cleaner 10 real time or at regular intervals (S5′).

After that, the controller 18 compares a traveling direction of the programmed working path with the rotation angle of the robot cleaner 10, calculated real time or at regular intervals (S6′).

As a result of step S6′, if the traveling direction and the rotation angle correspond, the controller 18 stops driving of the driving part 15 such that the traveling angle of the robot cleaner 10 is not changed any more (S7′).

After that, the controller 18 drives the motors 15e and 15f of the driving part 15 to continue traveling of the robot cleaner 10 (S8′).

The controller 18, while moving to a destination or traveling along the working path, determines whether the cleaning work or the monitoring work has been completed (S9′), and when the performance is not completed, processes of S3 through S9′ are repeated until the performance is all done.

As can be appreciated from the description of the mobile robot, the mobile robot system and the path compensating methods, according to embodiments of the present invention, the rotation angle can be correctly measured by the vision cameras 13 and 14 for compensation of the working path, without having to provide expensive devices such as an accelerometer or a gyroscope, thereby saving manufacturing cost.

While the invention has been shown and described with reference to certain embodiments thereof, it will be understood by those skilled in the art that various changes in form and details may be made therein without departing from the spirit and scope of the invention as defined by the appended claims.

1. A mobile robot comprising:
a mobile main body;
a driving part within the main body for driving a plurality of wheels;
a vision camera mounted on the main body to photograph an upper image perpendicular to a direction in which the mobile main body can travel; and
a controller, operatively coupled to the driving part and the vision camera, calculating a rotation angle using polar-mapping image data obtained from the vision camera by polar-mapping an image, photographed by the vision camera, said controller driving the driving part using the calculated rotation angle.

2. The mobile robot of claim 1, wherein the controller calculates the rotation angle by comparing current polar-mapping image data, obtained by polar-mapping an image photographed by the vision camera, with previously stored, polar-mapping image data.

3. The mobile robot of claim 1, wherein the mobile robot further comprises a vacuum cleaner having a suction part, a dust collecting part storing drawn-in dust or contaminants, and a suction motor part generating a suction force.

4. A mobile robot system comprising:
a mobile robot having a driving part driving a plurality of wheels and a vision camera mounted on a main body of the mobile robot to photograph an image perpendicular to a traveling direction; and
a controller, wirelessly communicating with the mobile robot, wherein the controller calculates a rotation angle using polar-mapping image data obtained by polar-mapping a ceiling image photographed by the vision camera, said controller controlling a working path of the mobile robot using the calculated rotation angle.

5. The mobile robot system of claim 4, wherein the remote controller calculates the rotation angle by comparing current polar-mapping image data, obtained by polar-mapping a current image photographed by the vision camera, with previously stored polar-mapping image data.

6. The mobile robot system of claim 4, wherein the mobile robot further comprises a vacuum cleaner having a suction part, for drawing in dust or contaminants, a dust collecting part for storing the drawn-in dust or contaminants, and a suction motor part for generating a suction force.

7. A method for compensating a path of a mobile robot, the method comprising the steps of:
storing initial polar-mapping image data obtained by polar-mapping an initial ceiling image photographed by a vision camera;
changing a traveling angle of the mobile robot, so that the mobile robot is diverted according to at least one of: a working path programmed in advance and an obstacle; and
after changing the traveling angle of the mobile robot, comparing the initial polar-mapping image data with current polar-mapping image data obtained by polar-mapping the current ceiling image photographed by the vision camera, thereby adjusting the traveling angle of the mobile robot.

8. The method of claim 7, wherein the adjusting step comprises the steps of:
forming current polar-mapping image data by polar-mapping the current ceiling image photographed by the vision camera;
circular-matching the current polar-mapping image data and the initial polar-mapping image data in a horizontal direction;
calculating the rotation angle of the mobile robot based on a distance that the current polar-mapping image data is shifted in the initial polar-mapping image data; and
comparing the calculated rotation angle of the mobile robot with at least one of directions; a traveling direction according to a preset working path and a traveling direction for avoiding an obstacle, thereby controlling a driving part of the mobile robot to adjust the traveling angle of the mobile robot.

9. A method for compensating a path of a mobile robot, comprising the steps of:
storing initial polar-mapping image data obtained by polar-mapping an initial ceiling image photographed by a vision camera;
changing a traveling angle of the mobile robot, so that the mobile robot is diverted according to at least one of a working path programmed in advance and an obstacle;
while the robot cleaner changes the traveling angle, determining whether the traveling angle of the mobile robot corresponds to at least one of: directions; a traveling direction according to a preset working path and a traveling direction for avoiding an obstacle, by comparing the initial polar-mapping image data with real-time polar-mapping image data, obtained by polar-mapping the ceiling image photographed real time or at regular intervals by the vision camera; and
stopping changing of the traveling angle of the mobile robot when the traveling angle of the mobile robot corresponds to the at least one of the directions; a traveling direction according to a preset working path and a traveling direction for avoiding an obstacle.

10. The method of claim 9, wherein the determining step comprises the steps of:
forming real-time polar-mapping image data by polar-mapping the real-time ceiling image photographed real time or at regular intervals by the vision camera;
circular-matching the real-time polar-mapping image data and the initial polar-mapping image data in a horizontal direction;
calculating the rotation angle of the mobile robot based on a distance that the real-time polar-mapping image data is shifted in the initial polar-mapping image data; and
comparing the calculated rotation angle of the mobile robot with the at least one of the directions; a traveling direction according to a preset working path and a traveling direction for avoiding an obstacle, to determine whether the compared values correspond.
